(19) United States
(12) Patent Application Publication
(10) Pub. No.: US 2017/0277520 A1
(43) Pub. Date: Sep. 28, 2017

(54) SYSTEM AND METHODS FOR DEVELOPMENT OF VISUAL BUSINESS APPLICATIONS

(71) Applicant: Pablo Daniel Palma Keller, Santiago (CL)

(72) Inventor: Pablo Daniel Palma Keller, Santiago (CL)

(21) Appl. No.: 15/468,351

(22) Filed: Mar. 24, 2017

Related U.S. Application Data
(60) Provisional application No. 62/313,178, filed on Mar. 25, 2016.

(51) Int. Cl. G06F 9/44; G06Q 10/06

(52) U.S. Cl. CPC G06F 8/34; G06Q 10/067

(57) ABSTRACT

A system and methods for the development of data management applications are provided. In some embodiments, the system is represented as a “Head” that exchanges data with a “Body”, such that the Head is represented in the Business Rules and in the Body all computational elements needed to generate and use the data exchanged with the Head, are represented. The system represents business rules, uses in original form some graphic elements that make unnecessary the use of “textual programming languages.” For this reason, the Business Applications developed with the system and methods can be understood and maintained by a Business Analyst. The system and methods do not provide capabilities or impose restrictions on how the Body is built, activity that is addressed with the most appropriate technologies for each particular problem, and therefore this activity remains in the traditional IT field.

### CROSS REFERENCE TO RELATED APPLICATIONS

This application claims priority to and the benefit of the filing date of U.S. Provisional Application No. 62/313,178, filed on Mar. 25, 2016, entitled “SYSTEM AND METHODS FOR DEVELOPMENT OF VISUAL BUSINESS APPLICATIONS”, which is hereby incorporated by reference in its entirety.

### BACKGROUND OF THE INVENTION

Generally, Enterprise Applications consist of computer programs that are built by specialized personnel who may be called programmers, software engineers or more generally, IT specialists. To build computer programs, these specialists can use different programming languages, some of which are named by way of example: C, C++, Basic, Fortran, Algol, Lisp, Java, JavaScript, Haskell, etc. To understand what these programs do, or to modify these programs, you may need to have specialized technical capabilities that in many respects are similar or equivalent to having programmers, software engineers or IT specialists.

Enterprise Applications can support different businesses that run on Companies. This means that different types of people such as employees, customers, suppliers, can use the business application to perform various actions that are considered part of the business.

Generally, within Companies there are people who can define, or execute, or modify, or make other types of actions related to the definitions of the business, here on called Business Analysts. They can use any of a variety of different ways to record the definitions of the business, which can be manual or automated.

Business analysts may not have the IT knowledge required to understand or modify computer programs that are part of the Enterprise Application.

Generally, for the same business in a company, the knowledge and information about the Business Application that supports the business, handled by Business Analysts and IT Specialists can substantially different. This situation can cause significant inefficiencies.

### BRIEF SUMMARY OF THE INVENTION

In one aspect, a method to identify and represent the main part of an Enterprise Application. A preferred embodiment is that this representation is graphic, and can use items such as “mental maps” or Blockly blocks (graphical platform from Google). This representation can be developed and modified by a Business Analyst and can be understood by anyone who knows the business.

In another aspect, a System that gives computer support to the main part of the business, that is executable.

A system and method to develop visual business applications is provided. This allows large applications development using a graphical representation of the problem. The method focuses on what we call the “head of the enterprise application” which typically represents 10% of the code of a business application that is represented with graphic forms that automatically generates a program that is executed by the computer. In the Head, business rules of the domain are maintained, which is what controls the aim and purpose of the business.

The methods allow, no matter the complexity of the application, it will always be possible to focus on specific aspects, according to the interests of the specialist working with it. Is an advanced form of knowledge management encapsulated in the enterprise application

A system and method for the development of Business Applications is provided. In some embodiments, the system is represented as a “Head” that exchanges data with a “Body”, such that in the Head the Business Rules are represented, and in the Body are represented all computational elements needed to generate and use the data exchanged with the Head. The system represents business rules, used in particular form and graphic elements that make unnecessary the use of “textual programming languages.” For this reason, the Business Applications developed with the system and methods can be understood and maintained by a Business Analyst. The system and methods do not provide capabilities or impose restrictions on how the Body is built, activity that is addressed with the most appropriate technologies for each particular problem, and therefore this activity remains in the traditional IT field.

### BRIEF DESCRIPTION OF THE DRAWINGS

FIG. 1A-FIG. 1A shows a block diagram of some of the elements of the System, from the design point of view, according to various embodiments described herein.

FIG. 1B-FIG. 1B shows a block diagram of some of the elements of the system, from the execution point of view, according to various embodiments described herein

FIG. 2-FIG. 2 shows a graphical representation of an example of a business application (called Map), according to various embodiments described herein.

FIG. 3-FIG. 3 presents a block diagram of a method to create and maintain a map, according to various embodiments described herein.

FIG. 4-FIG. 4 displays a list of example objects, which may be used in an Enterprise Application Map, according to various embodiments described herein.

FIG. 5-FIG. 5 shows an example of the attributes of the objects shown in FIG. 4, according to various embodiments described herein.

FIG. 6-FIG. 6 shows a method of the system according to various embodiments described herein.

FIG. 7-FIG. 7 shows an example of an execution sequence method, according to various embodiments described herein.

FIG. 8-FIG. 8 shows an example method for Mapping objects in the execution of an Enterprise Application, according to various embodiments described herein.

FIG. 9-FIG. 9 is an example to explain how the input files are integrated to produce the data structure used in the Calculus of the Business Application, according to various embodiments described herein.

FIG. 10-FIG. 10 is an example to explain how Calculus iterate upon the data structure to produce the Enterprise Application results, according to various embodiments described herein.

FIG. 11-FIG. 11 is an example to explain how data may be grouped to produce the Enterprise Application results, according to various embodiments described herein.

FIG. 12-FIG. 12 is an example to explain how the object Calculus may add values to the data structure, according to various embodiments described herein.

FIG. 13-FIG. 13 is an example used to explain some of the operations the Table could provide, which is one of the Objects used in the Map, according to various embodiments described herein.

FIG. 14-FIG. 14 is an example used to explain how the Grouper may be defined, which is one of the Objects used in the Map, according to various embodiments described herein.

FIG. 15-FIG. 15 is an example of some blocks defined in the system, to define the Assembly or the Calculus displayed on the Map, according to various embodiments described herein.

FIG. 16-FIG. 16 shows an example of blocks usage as identified in FIG. 15, to define an object 430 Assembly, according to various embodiments described herein.

FIG. 17-FIG. 17 shows a sample usage of the blocks identified in FIG. 15, to define an Object Calculus 440, according to various embodiments described herein.

FIG. 18-FIG. 18 illustrates an example process of the system which may be used to automatically generate reduced versions of the Map of an Enterprise Application, according to various embodiments described herein.

FIG. 19-FIG. 19 is an example of a method which can be used to provide the necessary specifications which may be done to construct a new Map view according to various embodiments described herein.

FIG. 20-FIG. 20 shows an example of a process that may be used to define an Enterprise Application based, for these purposes, in the interactions that may be performed with the system matter of this request according to various embodiments described herein.

FIG. 21-FIG. 21 shows an example of some interactions that the system, matter of this request, may provide according to various embodiments described herein.

FIG. 22-FIG. 22 shows an example of how additional information may be added to the Map Nodes, to complete the Enterprise Applications documentation according to various embodiments described herein.

FIG. 23-FIG. 23 shows an example of how the system, matter of this application, may contain a big amount of Calculus Objects, each of them associated to nodes of a Map Node according to various embodiments described herein.

FIG. 24-FIG. 24 shows an example of how could the effect on FIG. 23 be obtained, but using only Calculus Objects according to various embodiments described herein.

FIG. 25-FIG. 25 shows an example of a block diagram of an electronic device, which may be used to perform some of the steps of the disclosed methods, according to various embodiments described herein.

FIG. 26-FIG. 26 shows an example of a block diagram of a server, which may be used to perform some of the steps of the disclosed methods, according to various embodiments described herein.

### DETAILED DESCRIPTION AND BEST MODE OF IMPLEMENTATION

Embodiments of the disclosure will not be described in reference to the accompanying figures, where in like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of Which is solely responsible for its desirable attributes or Which is essential to practicing the embodiments of the disclosure herein described.

It is understood that a business application may be a software solution used by a company to support the development of the business, to solve problems related to the execution of their business, to provide useful background in developing their business, or to support any other business related activity within the company, etc.

A business application can be built using different forms and using different technical approaches, such as using any programming language, spreadsheets, databases or any other mean that is suitable for this purpose, although this list is not exhaustive. Specialists, who understand the techniques required to build it, using any of the mechanisms described above or other, are usually in charge of developing business applications. However, business users generally do not have the knowledge required to understand these developments, and therefore business users generally cannot modify business applications developed using the ways described above

The method and system illustrated in the different figures of this document, make possible to build business applications that usually may be understood by any business user, not having special technical knowledge

A preferred embodiment is that Business Applications may be developed using graphical elements such as, for example, mind maps, blocks and others. The applications developed with these elements may be easier to understand than those that use other means such as programming languages, Excel, etc.

A preferred embodiment may separate the business application into two parts that can be called head and body. In such case, the head may contain business aspects, or the applications main aspects or the applications decision rules, or what is technically known as “the business layer”, to allow the body of the application be developed in conventional manner that might not be necessary to be understood by a business user. Generally what has been called the head of the application, is the smallest part of the whole application and makes their development to be a minor part of the complete application development

A preferred Embodiment, containing some objects types that allow representing the head of the application on a simpler way to understand. These objects can be called Inputs, Outputs, Tables, Assemblies, Calculus, Constants and Groupers. These objects are explained in the examples, which are associated to the figures.

Tables Object can be characterized as groups of conditions associated with values. The Groupers Object can be characterized because it gives a name to certain conditions that are used in the head of the application, and may have the properties of relying mainly on the input data, therefore can be invariants of the enterprise application.

Preferred embodiments may contain documentation that is associated with each of the items shown in the above Map, and that can be developed in part automatically and can be compact and easy to understand

Preferred embodiments that allow a large application can be made using the graphical development approach described above

Preferred embodiments allow all information of a business application to be analyzed, reviewed and presented according to specific needs, and therefore support the understanding of many specific aspects of the business application that might interest the user.

Preferred embodiments that allow following a working method that reduces the effort to build business applications compared to conventional methods as described above.

Examples of the System Architecture

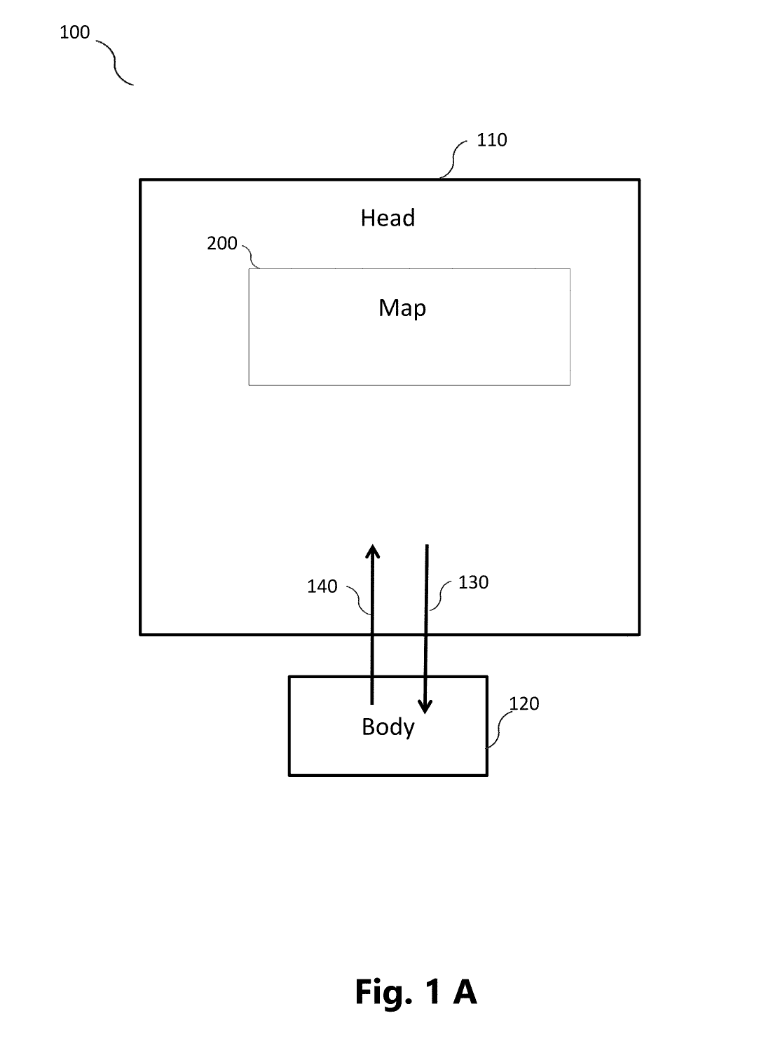

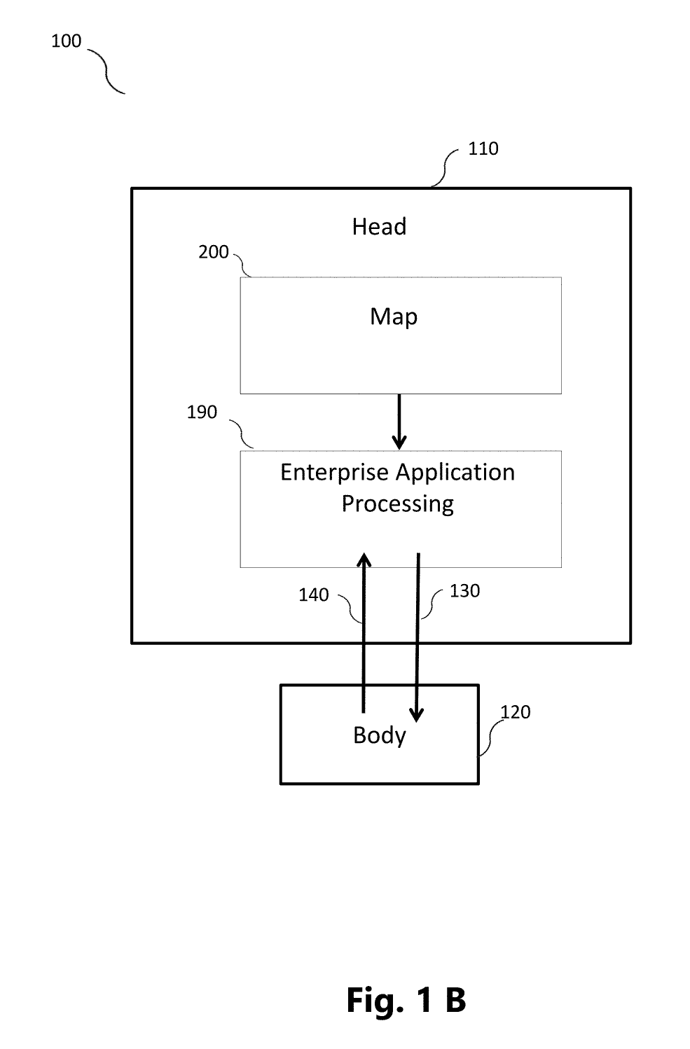

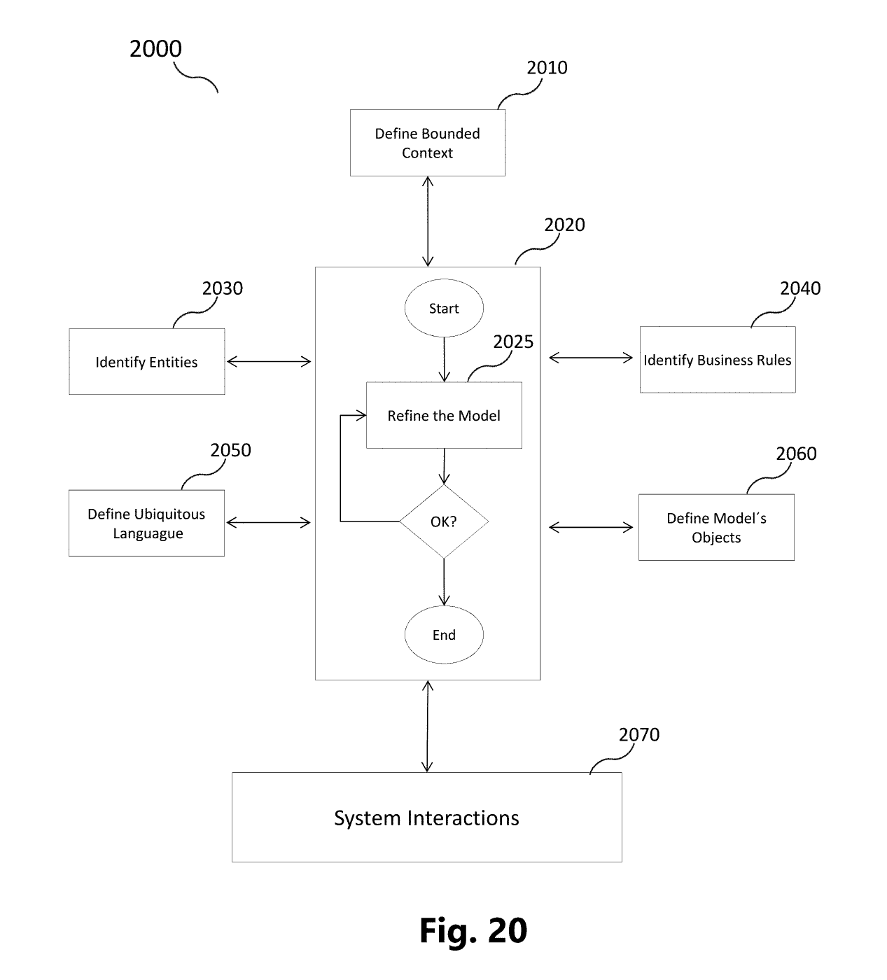

Referring to FIG. 1 A, in some embodiments, a Business Application 100 comprises two parts, a Head 110 and a Body 120. The Head may include a special capability to represent Business Rules, which are part of the process shown as example in FIG. 20. The Body of the Business Application may contain additional computational developments (databases, software, file systems, etc.) needed to provide the data required to process Business Rules, called Input 140, or to transfer the results generated by the Business Rules, called Output 130. FIG. 1A may be referred as the description of the Enterprise Application while FIG. 1B may be referred as the execution of the Enterprise

FIG. 1 B, shows how the system, matter of this patent request, may use the information contained in the Map 200 to process the Enterprise Application, that may be represented by block 190

FIGS. 1A, 1B, may have an Input 140 and an Output 130, generally but not exclusively, data that may be added corresponds to flat files in CSV format. Data transfer between the Head and the Body is performed through any available computer mechanism in the enterprise infrastructure, such as asynchronous transfer files, Web Services, integration bus, etc.

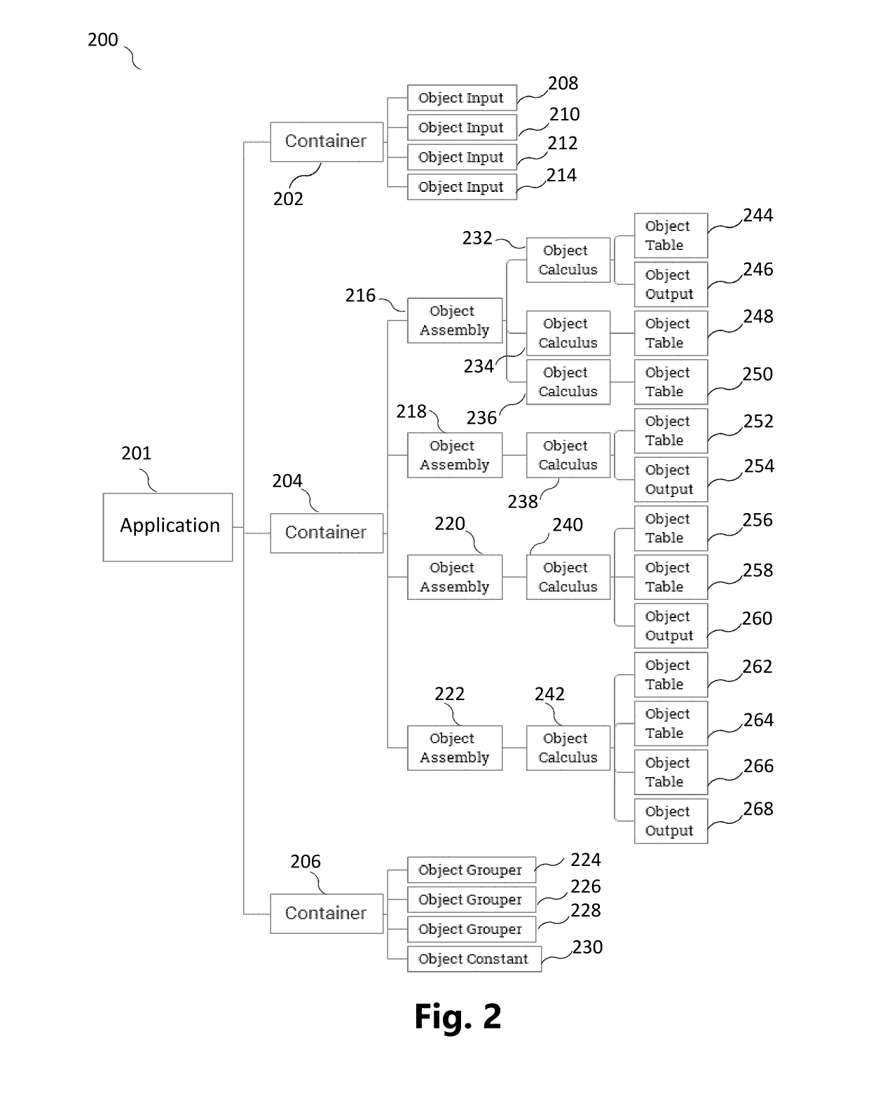

In FIG. 2, Map 200 is an example used for explanatory purposes of the methods of this system. The map may be a directed graph in which a parent may have multiple children, and a child may have several parents (does not have the restriction of a tree structure). Map nodes 202, 204, 206 . . . 268, show the objects that were used in the example of the Map 200, to represent Business Rules for that example. These objects are instances of 9 classes provided by the system, that can increase or decrease quantity wise or as well become instances of different classes.

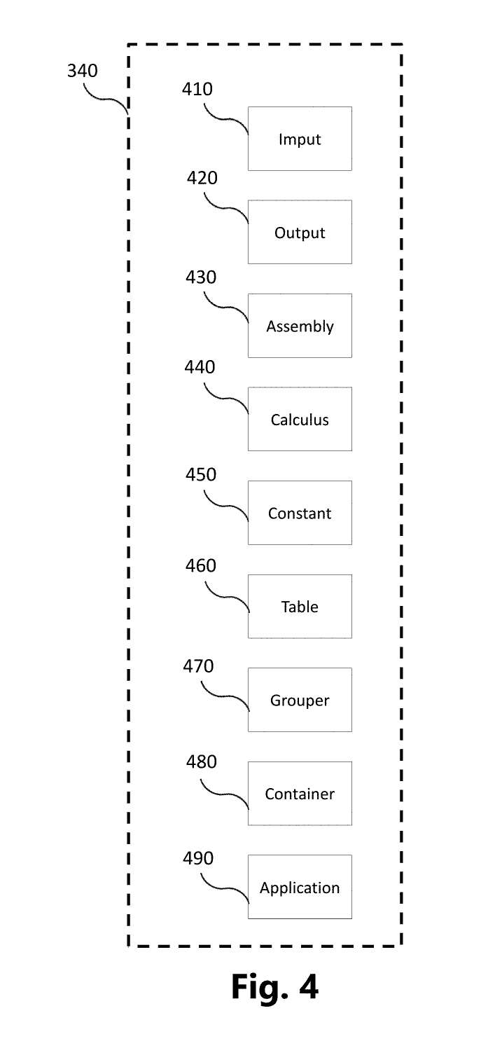

FIG. 4 shows some Software Classes that may be used to explain this patent application. Examples of some Software Classes in FIG. 4 are: Input 410, Output 420, Assembly 430, Calculus 440, Constant 450, Table 460, Grouper 470, Container 480 and App 490. Details of FIG. 4 are explained in the following paragraphs.

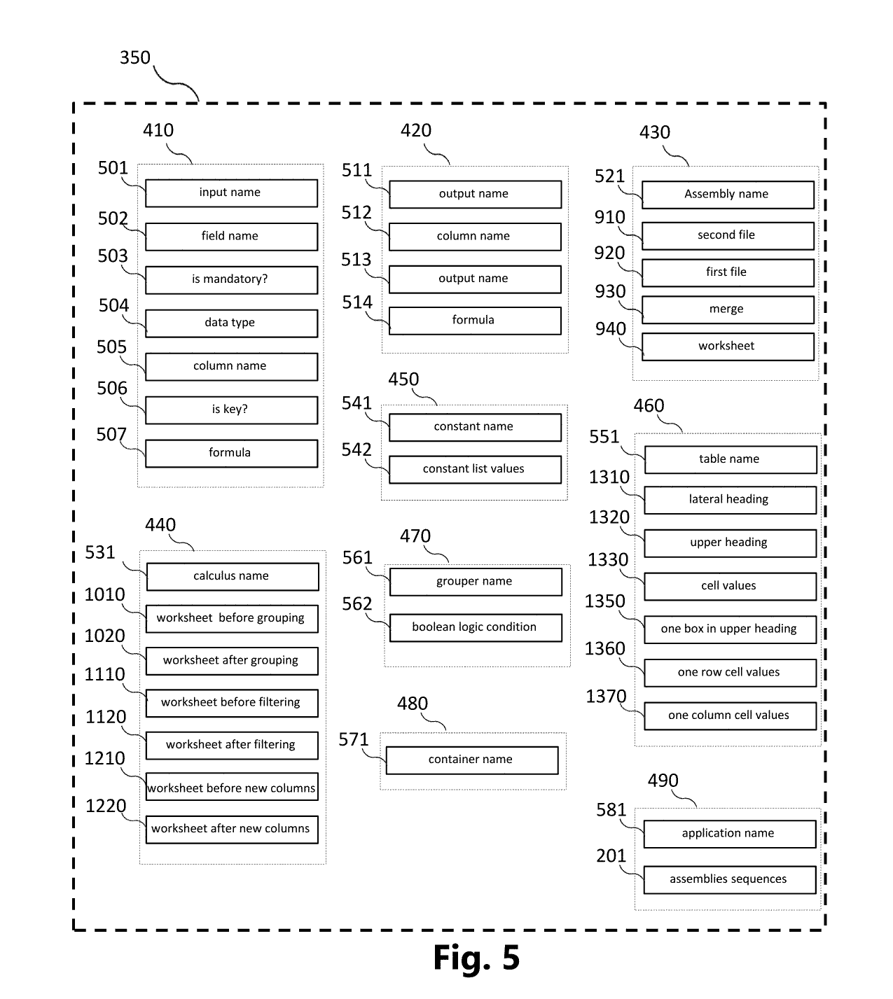

Input 410 in FIG. 4, may be used to define the files or records in which the data may be received in this system. Some example attributes of objects of this class are shown in FIG. 5.

Output 420 of FIG. 4. may be used to define the files or records in which data calculated according to this system, may be returned. Some example attributes of objects of this class are shown in FIG. 5.

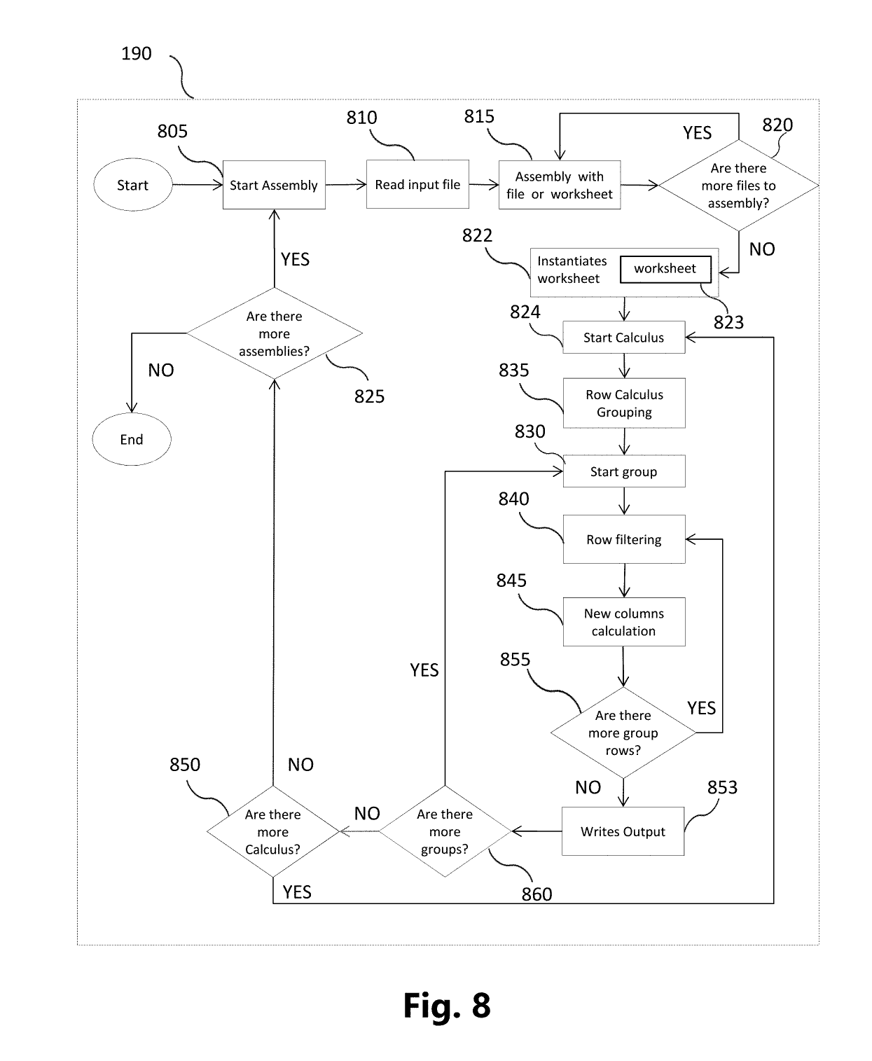

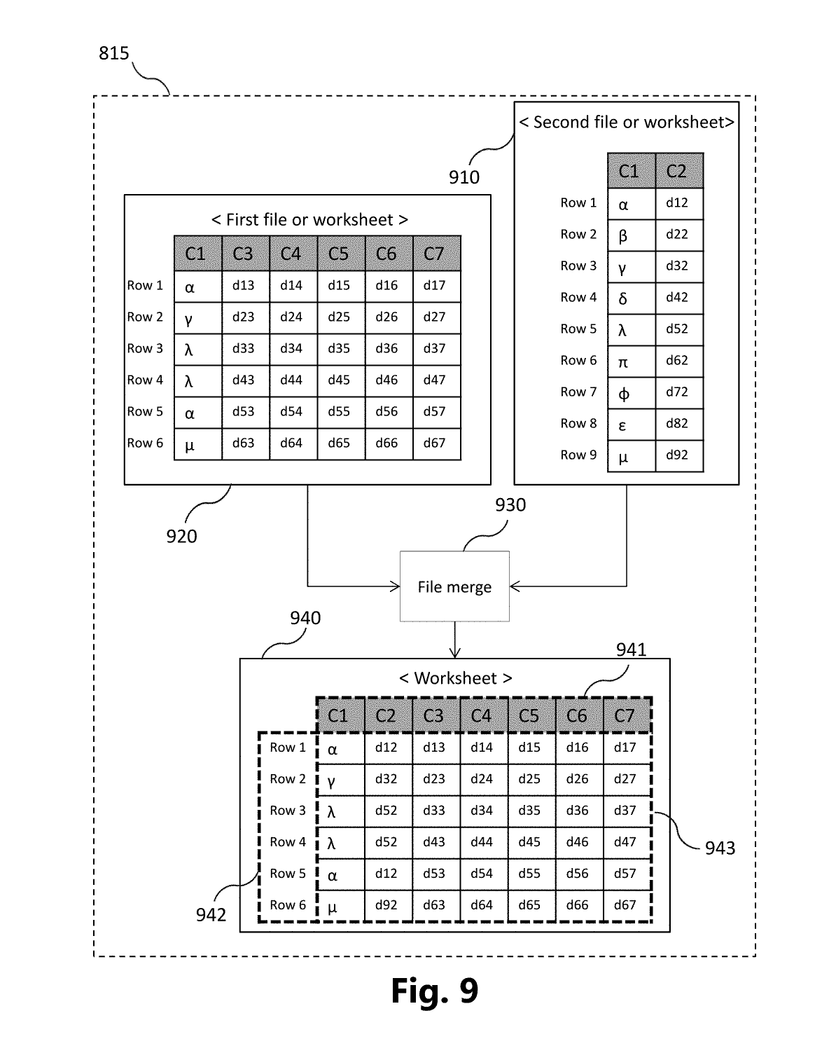

Assembly 430 of FIG. 4. may be used to define the integration processes for the information received as input. Flowchart of FIG. 8, is an example of the assembly process, that may be expressed by activities 805, 810, 815, 820. An example of a possible result of an assembly process is shown in FIG. 9, explained later.

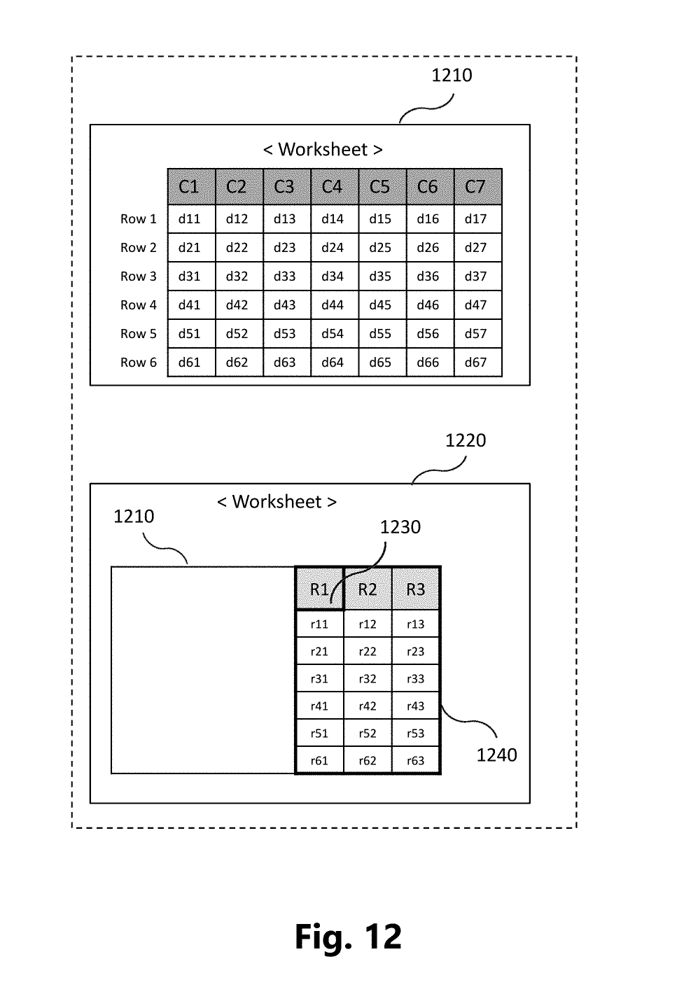

Calculus 440 of FIG. 4, may be used to define the generation of new values. Activities 830, 835, 840, 845, 850.855, 860 in Flowchart of FIG. 8, are an example of the process to generate new values. FIG. 12, which will be explained later, is a possible example of generated values.

Constant 450 in FIG. 4, may be used to define constants with similar characteristics as those used in traditional programming languages. A value assigned to a constant could be restricted to a set of possible values.

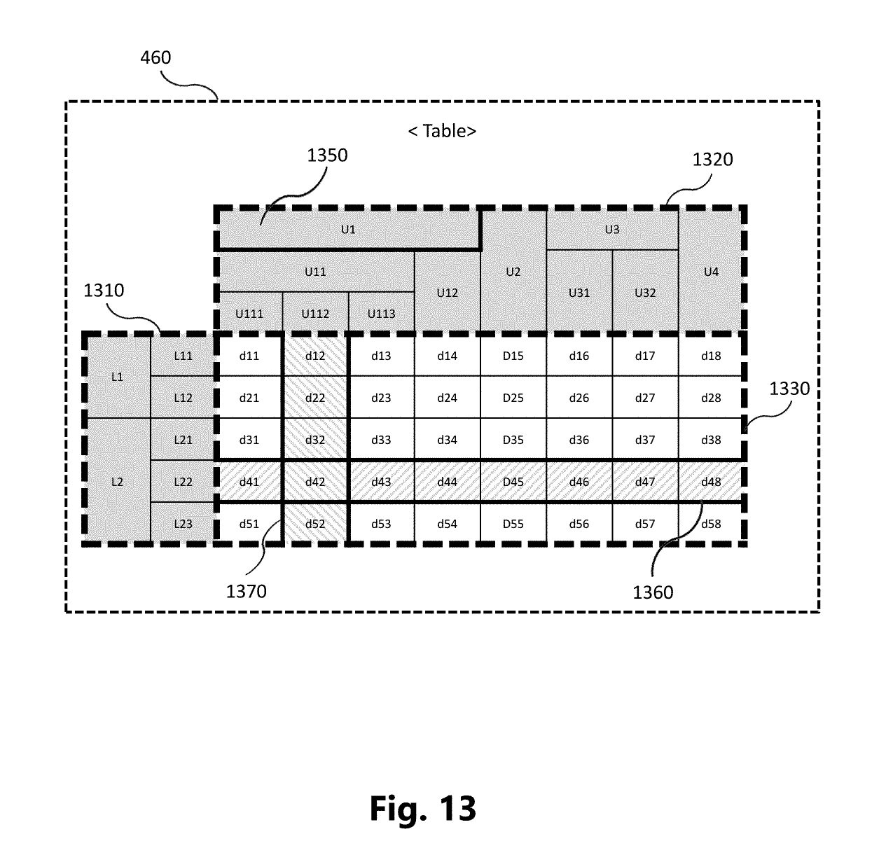

Table 460 in FIG. 4, may be used to bind conditions to values. A possible way, in which this binding is established, is shown by means of the example in FIG. 13, which will be explained later.

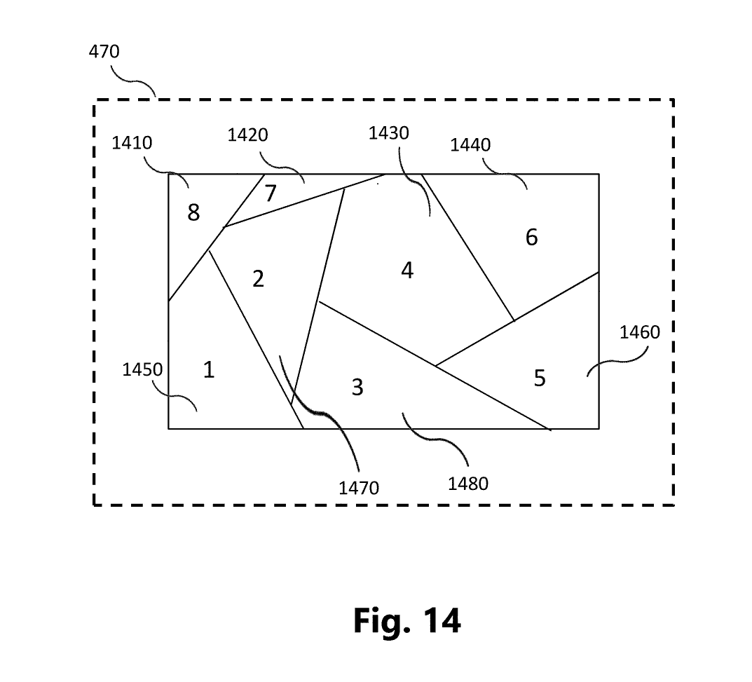

Grouper 470 of FIG. 4, may be a Boolean object (its values are true or false) used to identify grouping of input elements. Grouping that corresponds to names used within the Business Rules, I.E. “tropical fruits”, “winter fruits” of a certain type that receive different treatments within the Business Rules. They are characterized since the condition associated to them, depends only on input data and because in the Ubiquitous Language are expressed as adjectives associated with the element on which the groups are defined. The specific way they may be defined is shown in a particular example discussed in FIG. 14.

Container 480 of FIG. 4, this object may be used to group other objects, and one of its attributes may be its name.

Application 490 of FIG. 4, this object may be used to define the order in which the objects Assembly 430 are executed. A possible attribute of the object Application, is the ordered list of names of the objects Assemblies that the application has.

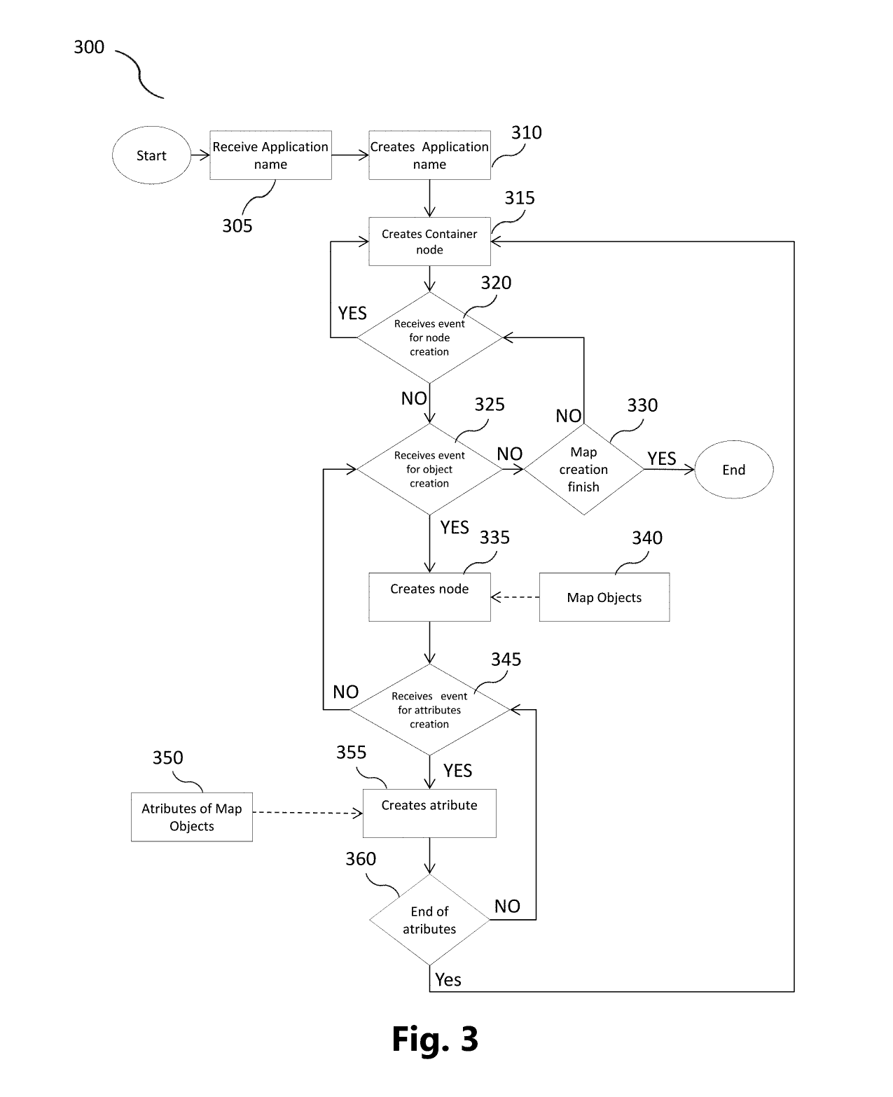

FIG. 3 shows a possible Flow Diagram of the Map editor 300, which can be used to build and modify the Map 200. The functioning of Map Editor, could have a cycle for node creation, and could include activities 325, 335, 345, 355, 360. This cycle could be nested within another cycle for Containers nodes creation, which includes activities 315, 320, 360.

When a new map is created, through the activity 305, the editor may receive the application name, and thus creates the first node of Map 310, which is associated with an object of Application type. Next, it can be created one or more nodes Container 315, each of which can have a name attribute. Each node Container 315 can be associated with one or more nodes corresponding to Object Classes, such as for example, ones identified in FIG. 4. Each of the nodes added to the map could be created, for example, with some of the attributes identified in FIG. 5. This could be done through the activities 345, 355, 360.

FIG. 5, is an example of the attributes that objects can have used in the Map 200. This example is illustrative only and does not cover exhaustively all the attributes that all objects may have. From a technical point of view, the attributes do not describe behaviors; therefore, FIG. 5 may show the intention of each attribute. There is no functionality associated with FIG. 5.

In FIG. 5, Object Input 410 may have the following attributes:
501 Input name correspond to the name of the object Input
502 field name, which is assigned to the 505 column
503 indication of whether the 502 field is mandatory or not
504 data type of the 502 field, which can be numeric, text, Boolean or date
505 column name, of each of the columns that has the Input
506 indication of whether the 502 field is or is not, a key ID registration
507 formula, specifies a calculated value according to others 502 field name

In FIG. 5, Object Output 420 may have the following attributes:
511 output name, which is the name of Object output.
512 column name, internal name in the software of the invention as it appears in the Output worksheet FIG. 12 Box 1230.
513 Output name corresponds to the column name on the worksheet output.
514 formula specifies a calculated value on the basis of other 512 column name.

In FIG. 5, the Assembly 430 Object may have the following attributes:
521 Assembly name, which is the name of Object Assembly 910 second file that could correspond to the file that is added to the 920 first file as shown in FIG. 8 activities 805, 810, 815 and 820.
920 first file, that could correspond to the main file that controls the process as shown in FIG. 8 activities 805, 810, 815 and 820.
930 that could correspond to the process to merge or generate the internal calculation worksheet, from the 920 first file.
940 worksheet, internal worksheet that is used by Calculus 440 to produce data that later appears in the Output 512 column name. Detailed explanation of the 940 worksheet will be delivered later.

In FIG. 5, the Calculus 440 Object may have the following attributes:
531 Calculus name, which is the name of Object Calculus.
1010 worksheet before grouping, which may correspond to the 940 worksheet as it looks after the assembly process.
1020 worksheet after grouping, which may correspond to 1010 worksheet before grouping, as it is after the grouping process 835 row calculus grouping of FIG. 8.
1110 worksheet before filtering, which may correspond to each of the group's rows after 1020 worksheet grouping.
1120 worksheet after filtering, which may correspond to 1110 worksheet before filtering, as it is after the 840 row filtering process of FIG. 8.
1210 worksheet before new columns, may correspond to each of the rows of the 1120 worksheet after filtering.
1220 after new worksheet columns, may correspond to the result of applying the Calculus to each of the rows of the 1210 worksheet before new columns. In this process, as new columns are added values of these, may be considered in the calculation of the following columns. Calculating a column is specified for all data in that column in each of the rows of the worksheet, and is associated with the column headers such as box 1230 of FIG. 12.

In FIG. 5, the Object Constant 450 may have only two attributes
541 Constant name, corresponding to the Object name Constant.
542 Constant list values, containing a finite or infinite set of values, one of which is chosen as the invariable constant value for the Enterprise Application Processing.

In FIG. 5, the Object Table 460 may have the following attributes
551 table name, which is the name of the Object Table.
1310 lateral heading, may correspond to a set of boxes that hierarchically grouped worksheet rows The hierarchy is constructed from right to left and is shown graphically as the size and relationship among the boxes as shown in box 1310 of FIG. 13.
1320 upper heading, may correspond to a set of boxes that hierarchically grouped worksheet columns. The hierarchy is constructed bottom up and is graphically displayed according to the size and relationship among the boxes as shown in box 1320 of FIG. 13.
1330 cell values, each of the 943 cells of a 940 worksheet on FIG. 9. The values of the 943 cells may be numbers, text or any type of data to be entered directly and are not affected by the Enterprise Application Processing.
1350 one box in the upper heading. Each of the boxes associated headers have a condition such as will be later explained.
1360 one row cell values, which are selected according to the conditions that are defined on the 1310 lateral heading.
1370 one column cell values, which are selected according to the conditions that are defined in the 1320 upper heading.

In FIG. 5, the Object Grouper 470 may have two attributes:
561 Grouper name, that corresponds to the name of the object Grouper.
562 Boolean logic condition, containing a Boolean expression based solely on data from files Input 410. This condition does not have restrictions on the input data or concerning the complexity of herself.

In FIG. 5, the Object Container 480 may have one attribute, 571 container name corresponding to the name of the Object Container.

In FIG. 5, the Object Application 490 may have two attributes 581 application name corresponding to the name of the Object Application 201 assemblies sequences corresponding to an ordered list according to which are executed different Assemblies 430 defined on the Map.

FIG. 9, 940 worksheet is an example of the internal structure that can be used throughout the Enterprise Application Processing. It could be an object not present in the Map.
The 940 worksheet structure can be similar to a spreadsheet.
The columns 941 may have an assigned name heading. Associated to the column name exists a formula that is part of a Calculus, which allows to assign values to each of the cells in the column.
Rows 942 have no header and contain the values that appear in cells 943
Cells 943 contains pure values that have no associated names or formulas, and can be of any data type, numeric or text.

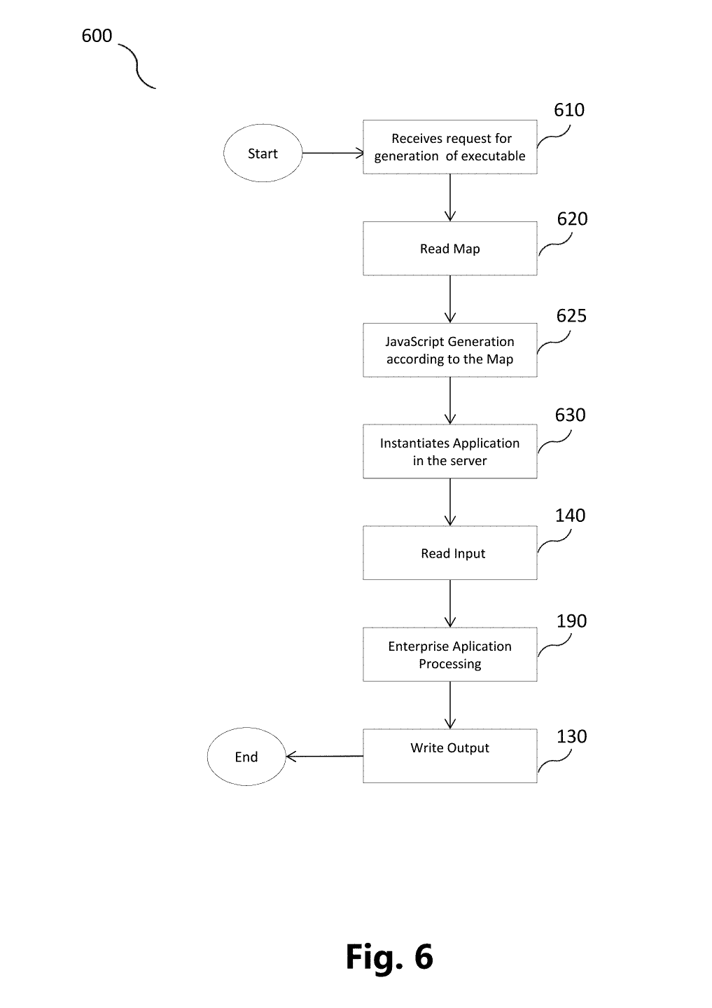

FIG. 6, shows the process through which the graphic elements of the Map 200 may be transformed into compiled code, required to be processed by a computer. This way of working could ensure that the system will run as it appears in the latest version of the Map 200. This process precedes the one described in FIG. 8, which is responsible for producing the expected results of the Business Application.

FIG. 6 is an example of a flowchart that can explain the execution of the Enterprise Application Processing:
Activity 610 “Receive request for generation of executable” is an event that begins the 190 Enterprise Application Processing.
Activity 620 “Read Map” is to review the database in which Map specifications are stored. This revision is made following a guideline that can take into account the location of the nodes on the Map, as their attributes.
Activity 625 “JavaScript generation according to the Map” interprets data read in activity 620 by a syntactic lexical analysis such as that performed by the compilers. The result could be the complete Enterprise Application expressed in JavaScript or in other programming language.
Activity 630 “instantiate the server application”, consists of a chain of utilities provided by the operating systems for these purposes.
Activities 140 “read input” and 130 “write outputs” refer to files transfer between the Head and the Body. Aggregated data files generally but not exclusively correspond to flat files in CSV format.
Activity 190 Enterprise Application Processing is detailed in the flowchart of FIG. 8.

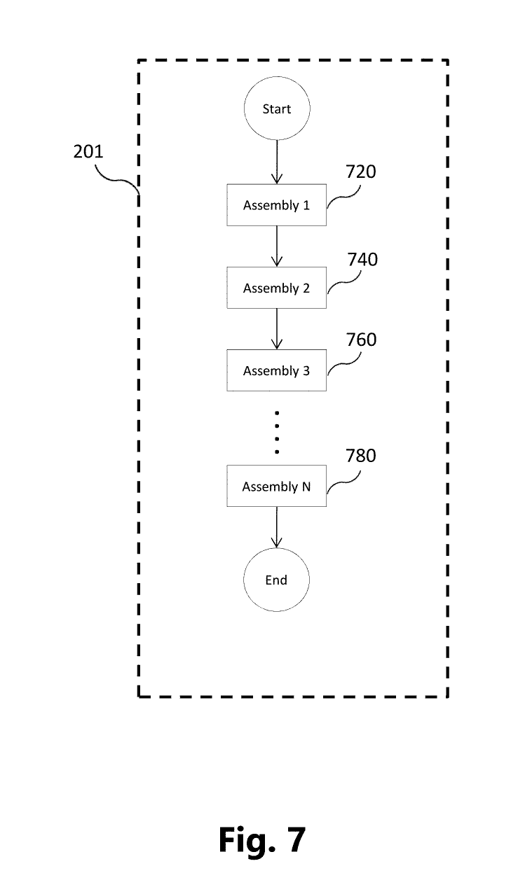

FIG. 7 shows an example of a sequence in which the Business Application may be executed. The sequence of execution follows the order of the Assemblies that are part of the Map.

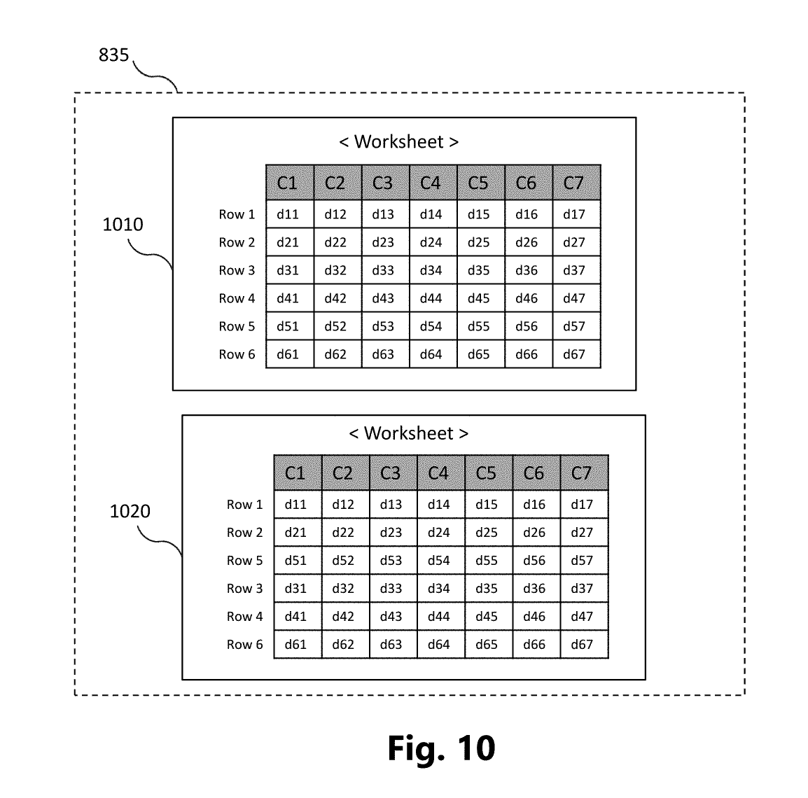

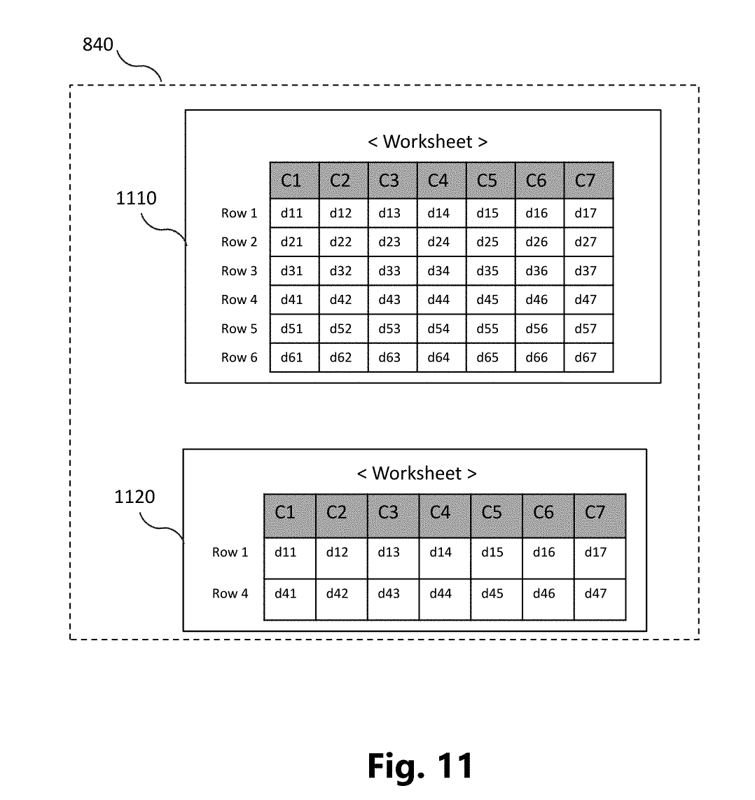

FIG. 8, shows an example of the Enterprise Application processing
Activities 805 “Start Assembly”, 810 “Read Input file”, 815 “Assembly with file or worksheet”, 820 “Are there more files to assembly”?, 822 “instantiates worksheet” and 825 “Are there more Assemblies?, may be a way to execute all the 430 Assemblies defined in the Map.
A possible detail of Activity 815 “assembly with file or worksheet” is shown in FIG. 9.
Activities 824 “start Calculus”, 835 “Row Grouping Calculus” and 850 “are there more Calculus” is an example of a possible cycle to process all Calculus associated with the same Assembly.
Activities 830 “Start Group”, 840 “Row filtering”, 845 “New column calculation”, 855 “Are there more group rows” and 853 “Write Output” is an example of a possible process of each of the groups that are generated for a given Calculus.
Activities in FIG. 8 may be focused to process data of Input 140, while the activity 853 may generates the Output 130.
A possible detail of Activity 835 “row Calculus grouping”, is shown in FIG. 10.
A possible detail of Activity 840 “row filtering”, is shown in FIG. 11.
A possible detail of Activity 845 “New columns calculation”, is shown in FIG. 12.

FIG. 9 shows a possible example of activity 815 “Assembly with file or worksheet”.
Boxes 920 and 910 represent possible examples of input files Input 410. They may also be a 940 worksheet that may previously be produced in another 440 Assembly process.
A way to associate files may be declaring a column in each file as a value match column. In this case, the C1 in 910 “second file” and C1 of the 920 “first file” have their values represented by Greek letters.
In row 920 “first file” C1 may have repeated values, but in C1 of 910 “second file” may not have repeated values. If there were repeated values 910 “second file” may consider the row associated to the first repeated value.
A possible example of information integration process 930 “File Merge” is shown in the 940 worksheet, which has both columns of input files for those rows that have been associated as off the values of the C1 910 “second file” and the C1 920 “first file”. The resulting 940 “worksheet” includes C2 of 910 “second file” that does not exist 920 “first file”.

In FIG. 10, an example of activity 835 “Row Calculus Grouping” is shown. In this example,
If d11=d21=d51 and d31=d41=d61, the calculation may be done grouped by C1, case in which the rows of the worksheet 1020 can be in the order: Row 1, Row 2, Row 5, Row 3 Row 4, Row 6.
Calculus applied to this worksheet, as shown in the activities 830, 840, 845, 853 and 860 of FIG. 8, can be performed in two groups, the first group could be formed by Row 1, Row 2, Row 5 and the second group could be formed by Row 3 Row 4, Row 6. In these cases there may be aggregated operations such as adding the values of the column C5, which could perform the addition d15+d25+d55 and then could perform the addition d35+d45+d65.
Other group operations can be group average, group highest value, and group lowest value.
The processing may be done group by group and may conclude when every row of the worksheet is processed.

In FIG. 11, an example of activity 840 “row filtering” is shown. It could be stated that some rows may be included or excluded in the Calculus. For example, it might be specified: “filter when C1=d11 or C1=d41, case in which the resulting worksheet 1120 may have 2 rows, for example Row 1 and Row 4.

In FIG. 12, an example of activity 845 “new columns calculation” is shown. Calculus may be executed from left to right, and the result r11 may be calculated using some of the d11, d12, . . . d17 data. The result r12 may be calculated using some of the data r11 and d11, d12 . . . d17. The result r13 may be calculated using some of the data, r11, r12 and d11, d12 . . . d17. Row 2, row 3, row 4, row 5, row 6, may follow the same previous pattern. The processing of this worksheet could be made row by row sequentially.

In FIG. 13, an example of the Object Table 460 is shown.
The structure of Table 460 may comprise three main parts, the 1330 cells, 1320 upper heading and 1310 lateral heading.
1330 cells may contain pure values that could not have an associated name or formula, and could be any data type, numeric, text, Boolean, etc.
1320 boxes of “upper heading” and 1310 boxes of “lateral heading”, can only have associated a Boolean value as well as an associated label. For example the 1350 box could be called “tropical fruit” and the condition associated with the same box could be Name=Mango OR name=Pineapple OR name=Banana.
Condition to select one column may be done applying the “AND” operator upon the conditions associated to each of the boxes piled on top of the column. For example: 1370 column is selected when condition U1=True AND condition U11=True AND condition U112=True.
Condition to select one row may be done applying the “AND” operator upon the conditions associated to each of the boxes piled to the left of the row.
The associated value to cell d42 can be returned when Table 460 is used having column 1370 and row 1360 are selected.

In FIG. 14, an example of a set of Groupers 470 is shown. In this case each of the Groupers may be defined upon the values of an Input 410 field called “fruit name”. In this example the set of Groupers 470 comprise eight groupers, each of which may have a unique name. Each of the Groupers may be defined by sets of values within a universe of possible values. The Grouper 1450 comprises the values “banana, pineapple, mango” and the Grouper 1470 comprises the values “blackberry, raspberry, strawberry”. The Grouper 1450 name may be “IsTropicalFruit” and the Grouper 1470 name may be “IsBerrie”. Each of them is a Grouper having a “true” or “false” value. When a record of the file Input is read, the value of “name of a fruit” with each Groupers associated with that field values are compared. Only one of them may be true and the rest may be false The Groupers in the set of Groupers 470 may be used as conditions associated to the headings of the Object Table and also could be used in the Object Calculus.

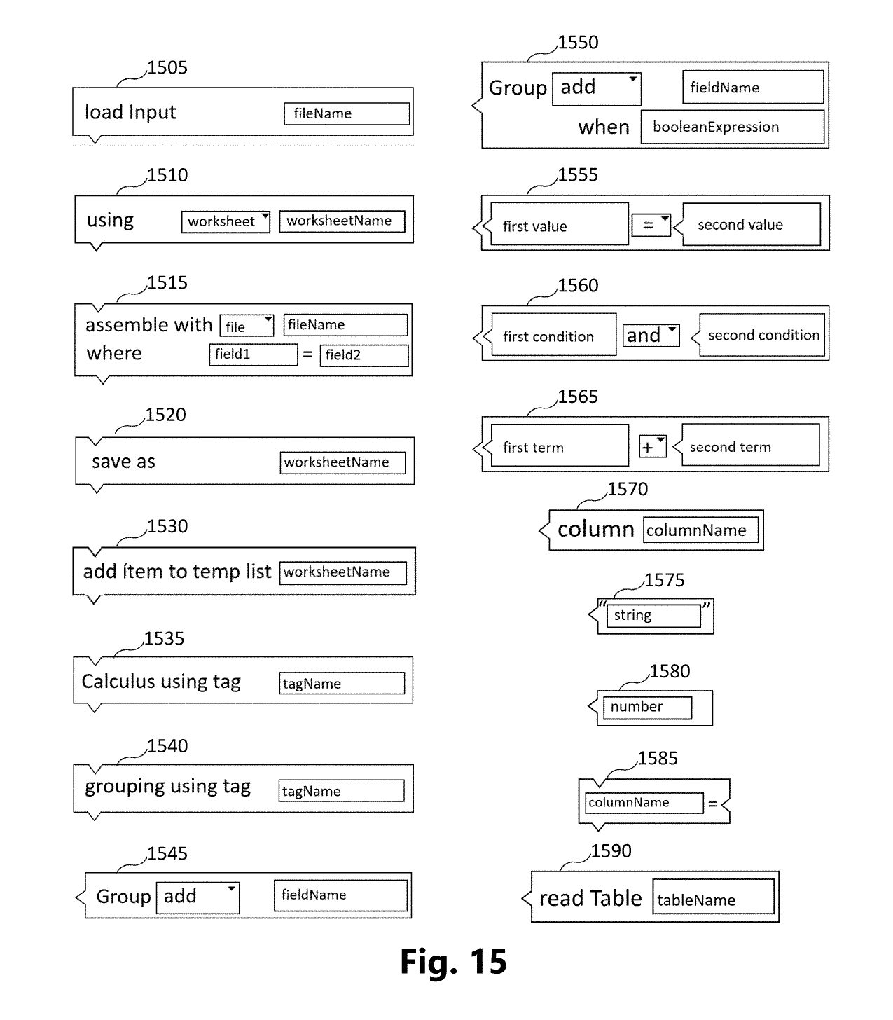

In FIG. 15, an example of the blocks used in the system to edit (create or modify) the Objects Assembly 430 and Calculus 440 is shown. The general operation of the blocks is defined in the Blockly's Google platform. Blockly is an example of the technology used by the system, although other similar graphic platforms may be used. Blockly specification is available on the site https://developers.google.com/blockly/. What follows are some examples of additional blocks that could be required by the system.
Block 1505 may be used to specify the first file involved in an Object Assembly, as exemplified in FIG. 9.
Block 1510 may be used to specify a Worksheet as the first element of an Object Assembly.
In any of the above two cases, the block 1515 may be used to specify the second element of an Object Assembly, as exemplified in FIG. 9. The second element can be either an Object Input 410 or a Worksheet. In block 1515, the name “field1” and the name “field2”, of the first and second element above referenced, may be used as a key to produce the match between the rows of the two elements of the Object Assembly.
Block 1520 may be used to specify the name of the Worksheet that is created in the Assembly, as exemplified in FIG. 9.
Block 1530 may be used to create an additional Worksheet, and Object Calculus 440 may create each row of that additional Worksheet.
Block 1535 may be used to invoke processing the Calculus that have the same value tag (the tag is a tag that can be associated to Calculus).
Block 1540 may be used to control the evaluation of the Object Groupers, based on the values of the Object Inputs fields.
Block 1545 is used to specify aggregated operations, where aggregated operations are values associated to all rows of the same group (FIG. 10 shows an example of grouping rows). Block 1545 is an example for the addition of the values of “fieldName” for every row of the same group. Other aggregated operations can be average, maximum value, minimum value and counting.
Block 1550 can be used for the same purposes as the block 1545, but may allow selection amongst all the rows, only those that meet the WHEN condition specified in the same block.
Block 1555 is a standard Blockly block used for comparisons.
Block 1560 is a standard Blockly block used for Boolean operations (to compose conditions).
Block 1565 is a standard Blockly block used to do arithmetic operations between two terms.
Block 1570 may be used to read column values of the Worksheet.
Block 1575 is a standard Blockly block used to assign a value of a string type.
Block 1580 is a standard Blockly block used to assign a numeric value.
Block 1585 may be used to assign a value to a new column in the Worksheet.
Block 1590 may be used to obtain the value of a cell from an Object Table.

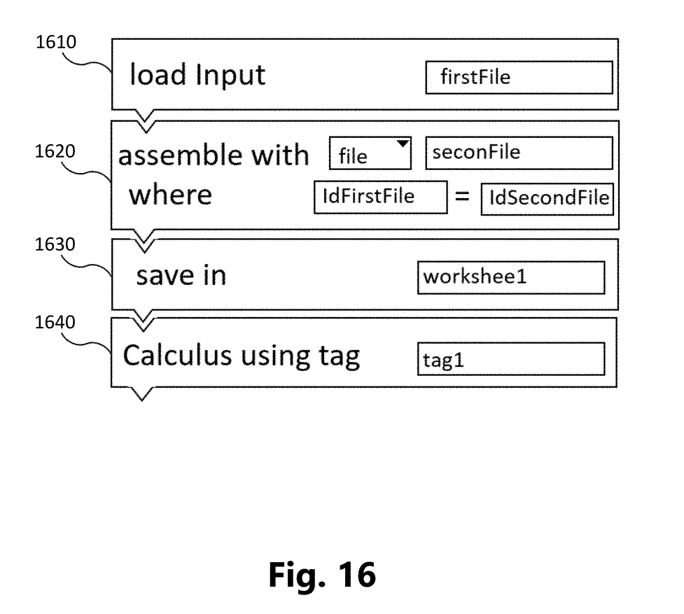

FIG. 16 shows an example of the use of blocks explained in FIG. 15, to define an object Assembly 430.
Block 1505 may read and load an Object Input 410, which in this case may be named “first file”.
Block 1515 may read a second Object Input 410, this time may be called “secondFile” and may declare that the match keys are filet for the first file and file2 for the second file.
Block 1520 may declare that the Worksheet name that is created in this Assembly is “worksheetName”.
Block 1535 may specify that Object Calculus 440 that is executed associated to the Assembly in FIG. 16, are those with a tag with the value “tagName”.

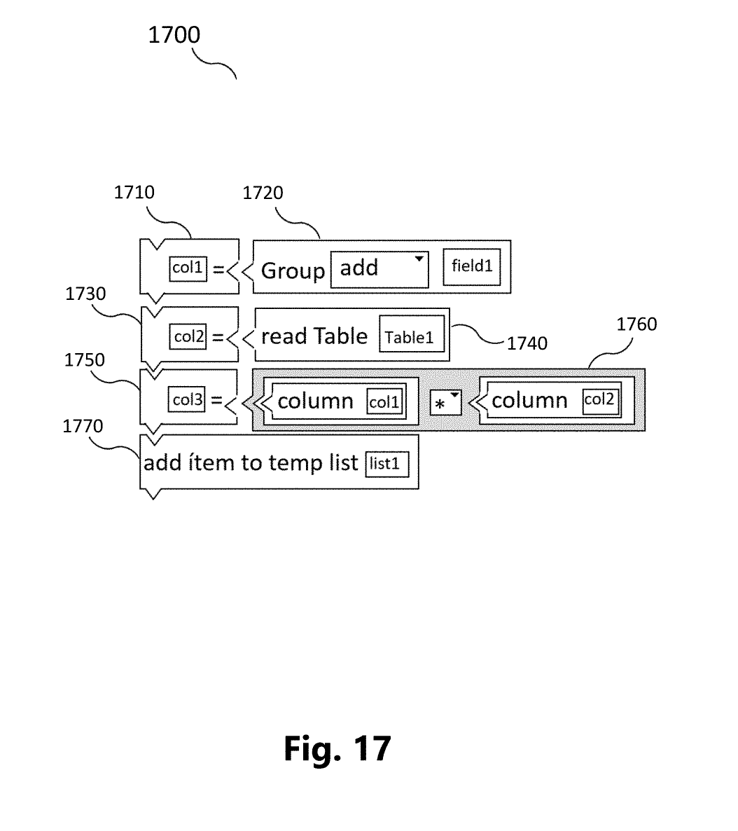

FIG. 17 shows an example of how blocks explained in FIG. 15, may be used to define an object Calculus 440.
Blocks 1585-1, 1585-2 and 1585-3 are different instances of the block 1585.
Blocks 1585-1, 1585-2 and 1585-3 may create columns named “col1”, “col2” and “col3” respectively.
Block 1545 may assign to col1 the addition of field values “field1”, for all rows in the same group.
Block 1590 may assign to col2 the value obtained by reading the Object Table 460, named “Table1”, for all rows in the same group.
Block 1565 may assign to col3 the result of multiplying col1*col2.
Blocks 1530 may state that these results will be stored in a different Worksheet than the standard Worksheet, called “list 1”. The standard Worksheet may be associated to the Systems Object Assembly.

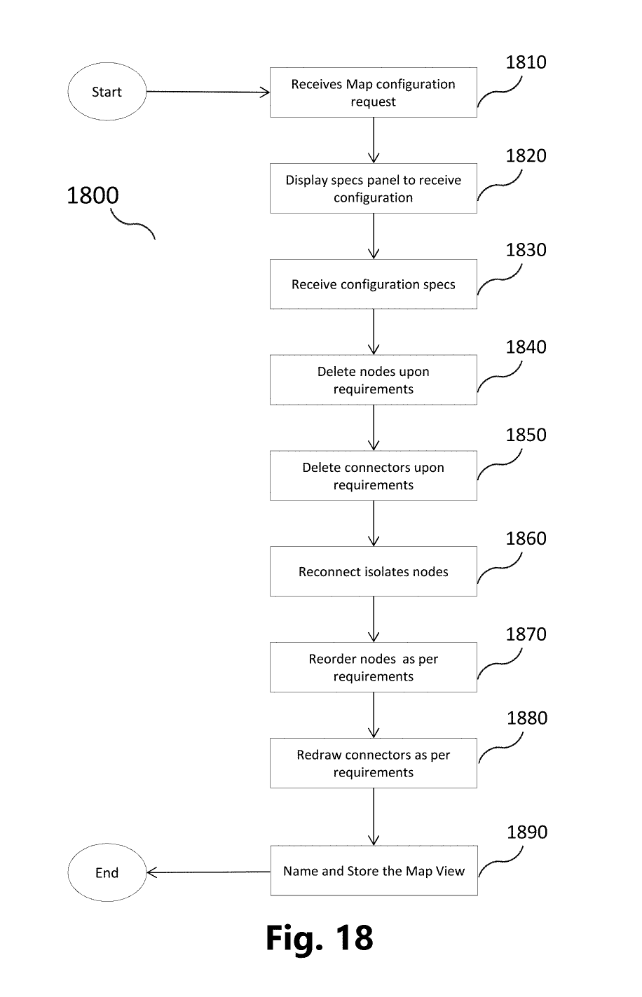

FIG. 18 shows a possible example of the process applied to the Map 200 to selectively generate different specialized views. These views may enable to focus on some specific aspects of the Map 200 that are suitable for analysis or understanding the Business Application model. This process may comprise the following activities:
Activity 1810 “receive map reconfiguration request”, may start the process to generate a new view.
Activity 1820 “display specs panel to receive configuration”, may expose an interface that may be used to express any criteria that could be used to add or reduce nodes and/or connectors between nodes in the Map.
Activity 1830 “receive configuration specs”, may be used to receive criteria that could be used to add or reduce nodes and/or connectors between nodes in the Map.
Activity 1840 “Delete nodes upon requirements”, may apply criteria to remove nodes that may not be needed in the new view.
Activity 1850 “delete connectors upon requirements”, may remove connectors between nodes that may not be needed in the new view.
Activity 1860 “reconnect isolated nodes”, may be the process by which nodes becoming disconnected in the Map (remain isolated), as a result of the above criteria application. The appropriate reconnection strategy may be chosen for the new view, based on above criteria.
Activity 1870 “reorder nodes as per requirements”, may receive additional distribution criteria.
Activity 1880 “redraw connectors as per requirements”, may receive additional connectors styles.

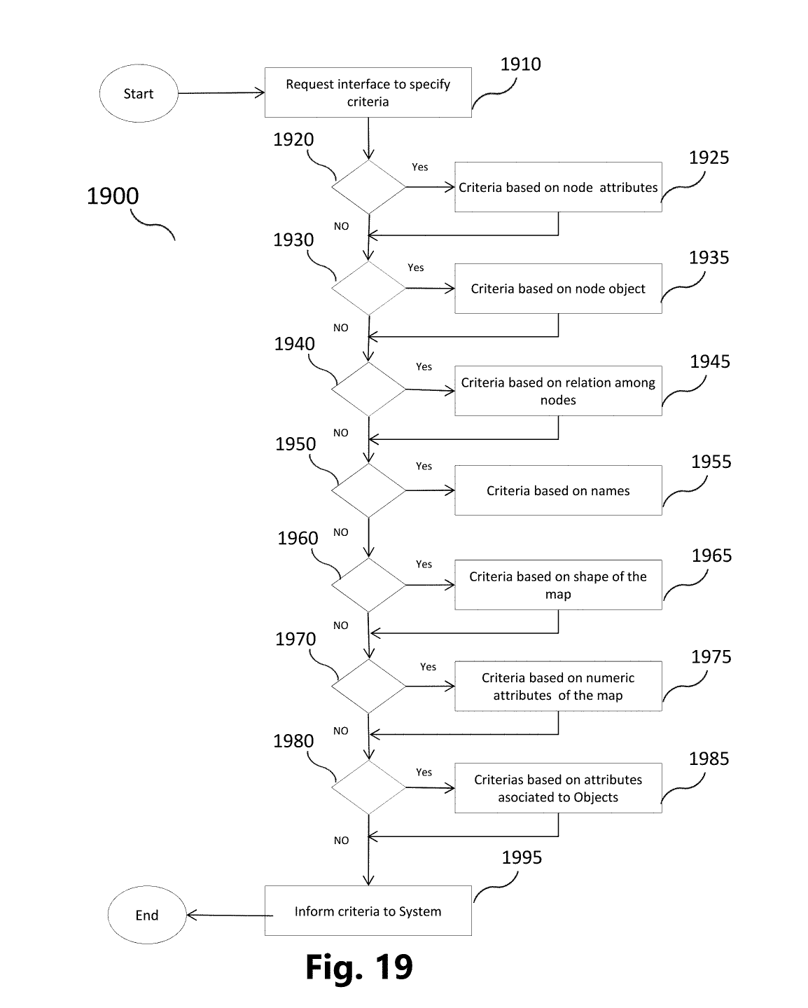

Referring to FIG. 19, in an exemplary embodiment, a diagram illustrates some of the criteria that may be used in the process to define new Map Views. The different types of criteria shown in the FIG. 19 are neither mandatory nor exclusive.
Activity 1910 may consist in requesting the system to provide an interface able to specify criteria. Such interface may be of any type and the way to specify criteria may be done by means of natural language or by filling special forms, or with a query language, etc.
Activity 1925 may consists of selecting criteria were reference may be made to Node attributes such as, for example, type of node, color, associated tag node, type of information associated to the node, markers associated to the node, etc.
Activity 1935 may refers to selection criteria where reference may be made to attributes of Object provided by the system that may be associated to the Node.
Activity 1945 may refers to selection criteria where reference may be made to existing relations among Map nodes, such as for example: antecessor or successor of another Node in the Map, Nodes within a given distance, Nodes that are part of the same Map view, Nodes belonging a certain demarcated Map zone, etc.
Activity 1955 may refer to selection criteria where reference may be done to different names that may be used anywhere in the application, such as for example: the place in which appears a specific name, names similarities, names having a common root, common or similar names for different elements, etc.
Activity 1965 may refers to selection criteria where references may be done to some Map special characteristics, such as for example: Nodes that make part of certain geometrical shapes (triangles, circles, etc.), nodes that lay at a certain distance to other nodes, nodes that lay in special map points (up, down, at the center, to the right, to the left, etc.), etc.
Activity 1975 may refer to selection criteria where reference may be made to some numeric Map attributes, such as for example: quantity of Nodes in a certain region, quantity of Nodes in a Map View, quantity of Nodes of a certain type, quantity of Nodes that have the same type of Object, etc.
Activity 1985 may refer to selection criteria where reference may be done to actions that may be associated with the Objects that appear as verbs used in Objects attributes.
Activity 1995 may give back to the System, the defined criteria for a Map views construction.

FIG. 20, in an exemplary embodiment, a block diagram shows the Method that can be used to construct an Enterprise Application using the capabilities offered by the System. In this diagram, some blocks correspond to concepts of the design methodology known as “Domain Driven Design” (DDD). Working with the Method may be facilitated by the functionality provided by the System.
Activity 2010 “Define Bounded Context” may corresponds to what is described in technical literature on DDD, but may be focused on the purpose of isolating the head from the body, as described before, in paragraph 00008.
Activity 2030 may consist on entity identification according to DDD methodology.
Activity 2050 may consist on defining the ubiquitous language according to DDD methodology.
Activity 2040 may consist in the identification of the business rules, that may be part of DDD's ubiquitous language associated to the business of to the Enterprise Application to be developed. The Methods of this Application may not establish any particular way to express business rules. Business Rules may be the primary declaration of intentions and characteristics of an Enterprise Application. They may express the particular way in which the defined business may be supported by the Enterprise Application. Business rules may not refer to “how” if not to “what”, and therefore may exclude any element of the solution itself. The process of recognizing what is and what is not a Business Rule may be a gradual process, which may be refined during the development of the Enterprise Application. At the end of the construction of the application, the rules may become sufficiently detailed and clearly represented.
Activity 2060 may define each of the Objects that may be required to develop the Enterprise Application.
Box 2070 may represent functionality that the System may provide to facilitate working with the Method.
Box 2020 represents the fact that the Method may be an iterative process, as it may by exposed by the loop containing activity 2025.

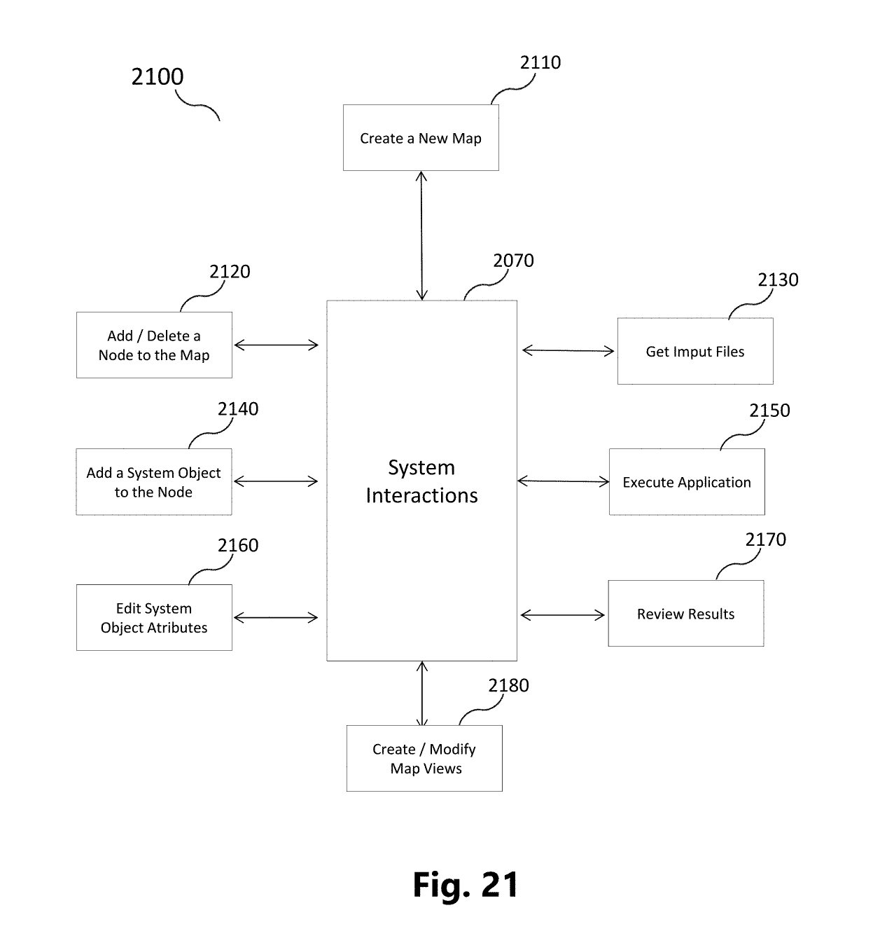

FIG. 21, in an exemplary embodiment, a block diagram that may illustrates interactions with the System, that me be helpful to support the Method
Box 2110 may allow the creation of a new Map for a new Business Application.
Box 2120 may allow adding or deleting Nodes to the Map.
Box 2140 may allow to associate to the Map Nodes, Objects of the System, as well as to delete existing associations.
Box 2160 may allow to edit Objects' attributes.
Box 2130 may allow to define Input Objects and make them available for processing.
Box 2150 may allow to execute the Business Application.
Box 2150 may allow to review results generated by the Business Application execution.
Box 2180 may allow to create or modify Map Views.

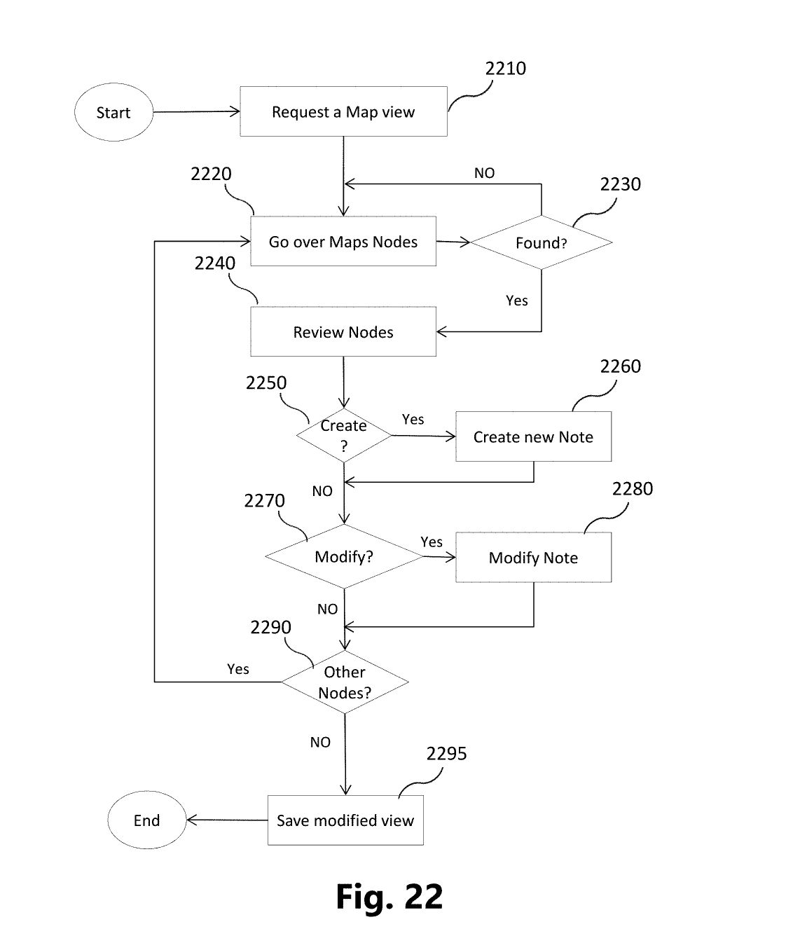

FIG. 22, in an exemplary embodiment, a block diagram shows a process that may generate Enterprise Application documentation, that may be performed by adding text notes to the Nodes that conform each of the Enterprise Application Map Views.
Box 2210 may allow to request a Map View to work with.
Box 2220 may allow to navigate thru the different Nodes in the Map View.
Box 2240 may allow the review notes associated to a Node.
Box 2260 may allow to create a new note.
Box 2280 may allow to modify an existing note.
Box 2295 may allow to save the Map View, that contains the updated set of notes that were added, modified or deleted and also the unmodified notes.

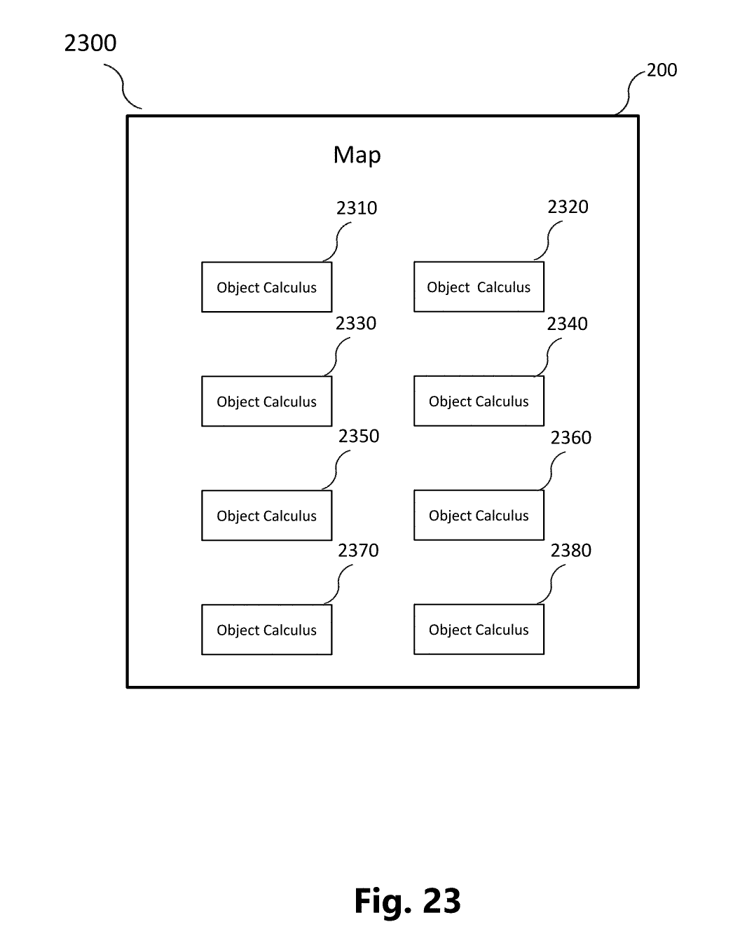

FIG. 23, shows a block diagram of a Map 200, that as an example, contains Calculus Objects, 2310, 2320, 2330, 2340, 2350, 2360, 2370, 2380. Each of the Calculus Objects could be defined using four blocks as shown in FIG. 17, so as a whole, these Calculus Objects may create 24 columns in a Worksheet. Method and System may it possible to have Maps with as many Calculus Objects as needed, and each of those built using a minimal number of blocks.

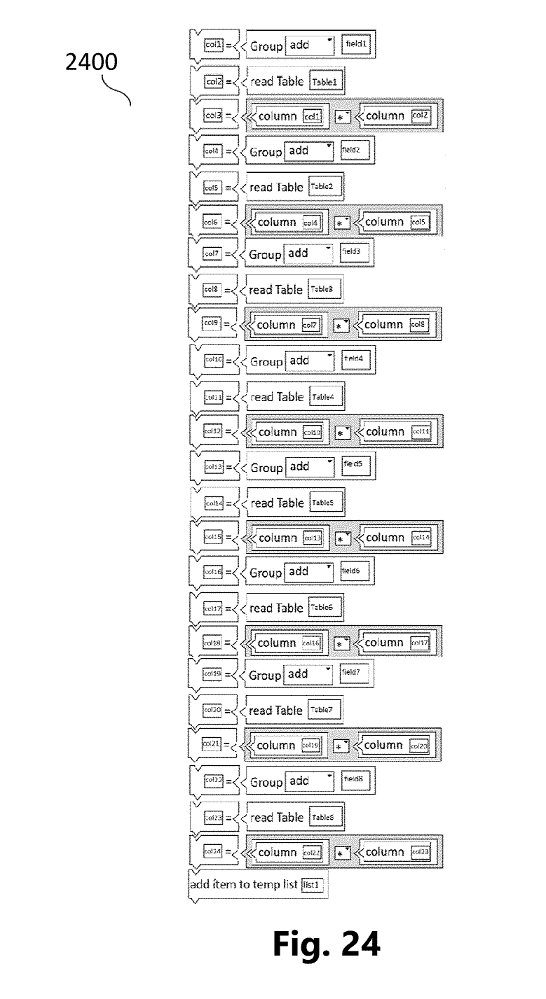

FIG. 24, shows a block diagram as a possible example to indicate how would it be to have only one Calculus Object to fill up the same 24 columns referenced in FIG. 23. This show that Method and System can permit to develop complex Enterprise Application made by many small Calculus Object.

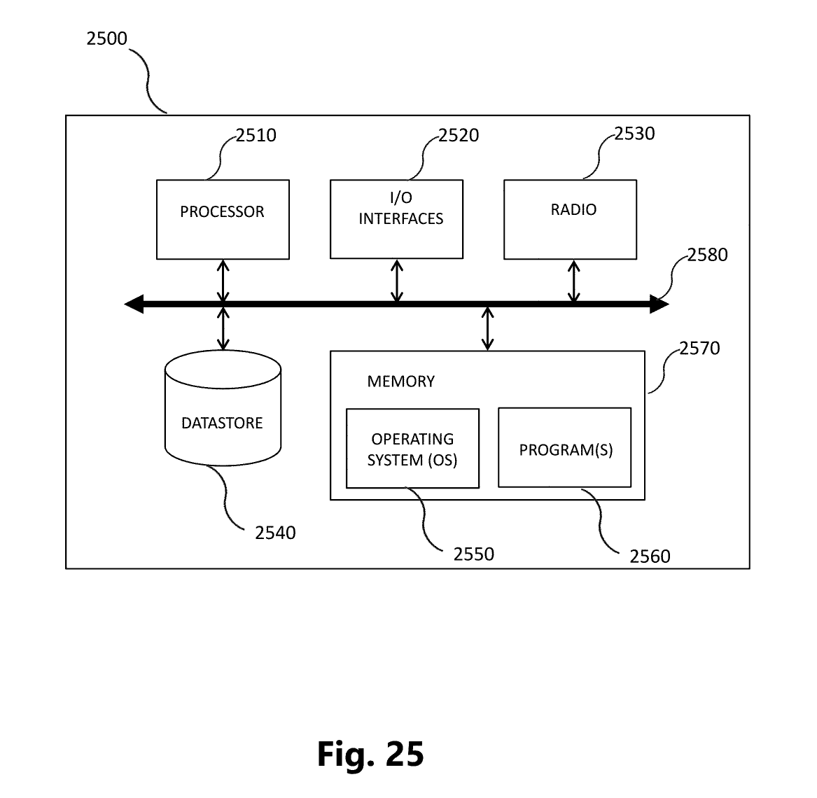

Referring to FIG. 25, in an exemplary embodiment, a block diagram illustrates an electronic device 2500, which may be used in the system 100 to perform steps of methods disclosed herein. The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, or any electronic device capable of running computer software and displaying information to a user. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The electronic device 2500 can be a digital device that, in terms of hardware architecture, generally includes a processor 2510, input/output (I/O) interfaces 2520, a radio 2530, a data store 2540, and memory 2570. It should be appreciated by those of ordinary skill in the art that FIG. 25 depicts the electronic device 2500 in an oversimplified manner, and a practical embodiment may include additional components and suitably configured processing logic to support known or conventional operating features that are not described in detail herein. The components (2510, 2520, 2530, 2540, and 2570) are communicatively coupled via a local interface 2580. The local interface 2580 can be, for example but not limited to, one or more buses or other wired or wireless connections, as is known in the art. The local interface 2580 can have additional elements, which are omitted for simplicity, such as controllers, buffers (caches), drivers, repeaters, and receivers, among many others, to enable communications. Further, the local interface 2580 may include address, control, and/or data connections to enable appropriate communications among the aforementioned components.

The processor 2510 is a hardware device for executing software instructions. The processor 2510 can be any custom made or commercially available processor, a central processing unit (CPU), an auxiliary processor among several processors associated with the electronic device 2500, a semiconductor-based microprocessor (in the form of a microchip or chip set), or generally any device for executing software instructions. When the electronic device 2500 is in operation, the processor 2510 is configured to execute software stored within the memory 2570, to communicate data to and from the memory 2570, and to generally control operations of the electronic device 2500 pursuant to the software instructions. In an exemplary embodiment, the processor 2510 may include a mobile optimized processor such as optimized for power consumption and mobile applications. The I/O interfaces 2520 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 2520 can also include, for example, a serial port, a parallel port, a small computer system interface (SCSI), an infrared (IR) interface, a radio frequency (RF) interface, a universal serial bus (USB) interface, and the like. The I/O interfaces 2520 can include a graphical user interface (GUI) that enables a user to interact with the electronic device 2500.

The radio 2530 enables wireless communication to an external access device or network. Any number of suitable wireless data communication protocols, techniques, or methodologies can be supported by the radio 2530, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 2540 may be used to store data. The data store 2540 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 2540 may incorporate electronic, magnetic, optical, and/or other types of storage media.

The memory 2570 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 2570 may incorporate electronic, magnetic, optical, and/or other types of storage media. Note that the memory 2570 may have a distributed architecture, where various components are situated remotely from one another, but can be accessed by the processor 2510. The software in memory 2570 can include one or more software programs, each of which includes an ordered listing of executable instructions for implementing logical functions. In the example of FIG. 25, the software in the memory 2570 includes a suitable operating system (O/S) 2550 and programs 2560. The operating system 2550 essentially controls the execution of other computer programs, and provides scheduling, input-output control, file and data management, memory management, and communication control and related services. The programs 2560 may include various applications, add-ons, etc. configured to provide end user functionality with the electronic device 2500. For example, exemplary programs 2560 may include, but not limited to, a web browser, social networking applications, streaming media applications, games, mapping and location applications, electronic mail applications, financial applications, and the like. In a typical example, the end user typically uses one or more of the programs 2560 along with a network such as the system 100.

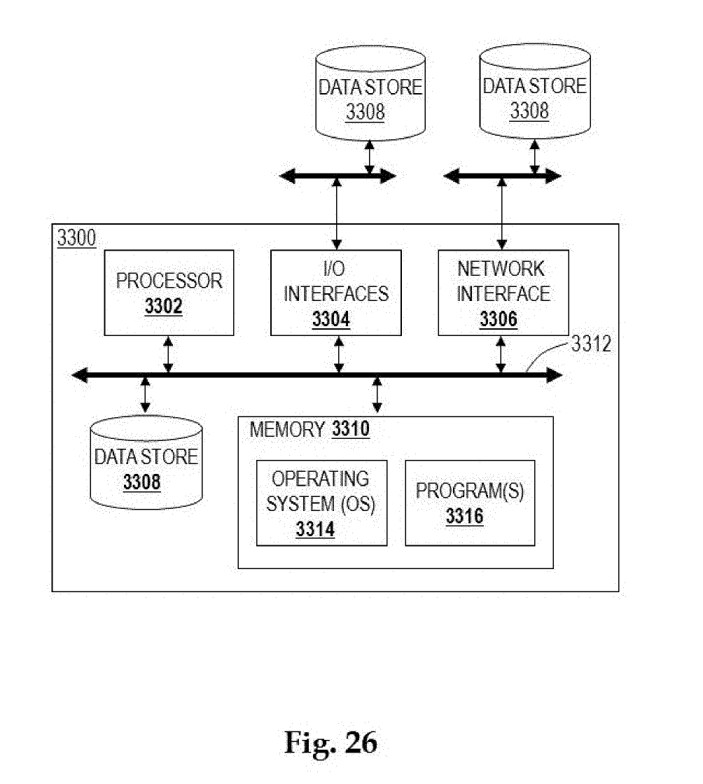

Referring to FIG. 26, in an exemplary embodiment, a block diagram illustrates a server 3300 which may be used in the system 100, in other systems, or standalone. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 26 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (O/S) 3314 and one or more programs 3316. The operating system 3314 essentially controls the execution of other computer programs, such as the one or more programs 3316, and provides scheduling, input-output control, file and data management, memory management, and communication control and related services. The one or more programs 3316 may be configured to implement the various processes, algorithms, methods, techniques, etc. described herein.

What is claimed is:

1. A computerized data storage and management system, the systems comprising a first head that exchanges data with a body, such that in the head one or more rules are represented, the body having one or more computational elements needed to generate and use the data exchanged with the head.
